(19) United States
(12) Patent Application Publication
(10) Pub. No.: US 2020/0385040 A1
(43) Pub. Date: Dec. 10, 2020

(54) FOLDABLE CART

(71) Applicant: GoBuggy Ltd., Toronto (CA)

(72) Inventors: James W. Rogers, Toronto (CA); Erin Binnie, Toronto (CA); Steve A. Copeland, Barrie (CA); Nicholas Teixeira, Angus (CA); Mitchell Thompson, Barrie (CA); Victoria Wright, Toronto (CA)

(73) Assignee: GoBuggy Ltd., Toronto (CA)

(21) Appl. No.: 16/886,867

(22) Filed: May 29, 2020

Related U.S. Application Data
(60) Provisional application No. 62/857,499, filed on Jun. 5, 2019.

(51) Int. Cl. B62B 3/02; B62B 5/06

(52) U.S. Cl. CPC B62B 3/022; B62B 5/0457; B62B 5/066; B62B 3/027

(57) ABSTRACT

A light weight, easy to maneuver general use utility cart that may be operated in a the forward push configuration wherein four wheels contact the ground and the cart may be pushed ahead of an operator or may be alternatively operated in a two-wheel dolly configuration wherein the cart may be pushed or pulled and easily maneuvered through tighter spaces and up/down stairs. Further, the cart of the present disclosure may be folded or collapsed into a compact configuration for easy storage utilizing minimal space.

### CROSS REFERENCE TO RELATED APPLICATIONS

This application claims the benefit of U.S. Provisional Application Ser. No. 62/857,499, filed on Jun. 5, 2019; the disclosure of which is incorporated herein by reference.

### BACKGROUND

### Technical Field

The present disclosure relates generally to the field of portable carts. More particularly, the present disclosure relates to a portable cart that may be manually maneuvered for transporting goods and materials. Specifically, the present disclosure relates to a portable cart for transporting goods and materials that may be manually maneuvered and may be rapidly switched between a cart configuration to a dolly configuration for ease of transport and maneuverability.

### Background Information

Utility carts are typically small, manually operated carts that are either pushed ahead of or pulled behind the operator to assist a person in transporting goods and materials from one location to another. Examples of utility carts include shopping carts, wire mesh carts (sometimes referred to as “granny carts”), utility dollies, furniture dollies, appliance dollies, and the like. These carts are available in various sizes and typically have between two and four wheels that contact the ground to assist the user in transporting heavy or unwieldy loads from one place to another.

Generally, utility carts fall into one of two categories, namely, general use and specialized use carts. For example, a general use cart may include a shopping cart or granny cart that may be used to carry groceries or other small personal items or effects. An example of a specialized use cart may be an appliance dolly which is designed to handle large, heavy and/or top heavy items, such as refrigerators, washers, dryers, ovens, and other similar appliances.

General use carts may have two or four wheels and tend to excel at carrying small to medium loads of generalized materials. These carts may also be difficult to maneuver in tight spaces and are not suited for traveling up or down stairwells. Further, these general use carts typically have a fixed configuration that makes them cumbersome to store and retain.

Conversely, specialized use carts, such as dollies, tend to have fewer wheels with a more upright profile that make them excellent for use in tight quarters and/or moving up and down stairs and are further easier to store. These carts are further useful in handling larger and heavier items, such as appliances, but suffer when used to transport multiple smaller items. For example, an appliance dolly is excellent for moving a refrigerator down a tight hallway or through a doorway, but it is of little or no use to take to the corner market to stock up on that day's groceries.

### SUMMARY

The present disclosure addresses these and other issues by providing a light weight, easy to maneuver general use utility cart that may be operated in a the forward push configuration wherein four wheels contact the ground and the cart may be pushed ahead of an operator or may be alternatively operated in a two-wheel dolly configuration wherein the cart may be pushed or pulled and easily maneuvered through tighter spaces and up/down stairs. Further, the cart of the present disclosure may be folded or collapsed into a compact configuration for easy storage utilizing minimal space.

In one aspect, an exemplary embodiment of the present disclosure may provide a foldable cart comprising: an upper frame extending generally upwards from a first rotation assembly and a second rotation assembly when the cart is in a first configuration; a front portion of a lower frame extending generally downwards and forwards from the first and second rotation assemblies when the cart is in the first configuration; a rear portion of a lower frame extending generally downwards and rearwards from the first and second rotation assemblies when the cart is in the first configuration; a first pair of wheels carried by the front portion of the lower frame for operational engagement with a ground surface; and a second pair of wheels carried by the rear portion of the lower frame for operational engagement with a ground surface.

In another aspect, an exemplary embodiment of the present disclosure may provide a method of reconfiguring a utility cart comprising: unlocking a first rotation assembly and a second rotation assembly of a utility cart; moving a rear portion of a lower frame of the utility cart from a first position wherein a rear portion of a lower frame extends generally downwards and rearwards from the first and second rotation assemblies to a second position wherein the rear portion of the lower frame is adjacent to a front portion of the lower frame extending generally downwards and forwards from the first and second rotation assemblies; and locking the first and second rotation assemblies in position.

In yet another aspect, an exemplary embodiment of the present disclosure may provide a method of transporting materials comprising: placing an item to be transported into a utility bin carried by a cart having an upper frame, a lower frame, a first pair of wheels operably connected to a front portion of the lower frame, and a second pair of wheels operably connected to a rear portion of the lower frame; causing the cart to be moved relative to a ground surface while in a first position wherein the first pair of wheels and the second pair of wheels are engaged with the ground surface; rotating the rear portion of the lower frame towards the front portion of the lower frame to a second position wherein the first pair of wheels do not engage the ground surface; and causing the cart to move relative to the ground surface in the second position.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front right perspective view of a foldable cart in a first configuration according to one aspect of the present disclosure.

FIG. 2 is a front right perspective view of a foldable cart in a second configuration according to one aspect of the present disclosure.

FIG. 3 is a rear left perspective view of a foldable cart in a third configuration according to one aspect of the present disclosure.

FIG. 4 is a front right perspective view of a foldable cart in the first configuration with additional utility baskets installed according to one aspect of the present disclosure.

FIG. 5 is a front elevation view of a foldable cart in the first configuration with additional utility baskets installed according to one aspect of the present disclosure.

FIG. 6 is a rear elevation view of a foldable cart in the first configuration with additional utility baskets installed according to one aspect of the present disclosure.

FIG. 7 is a side elevation view of a foldable cart in the first configuration with additional utility baskets installed according to one aspect of the present disclosure.

FIG. 8 is a cross sectional view of a portion of the handle and one arm of the foldable cart according to one aspect of the present disclosure.

FIG. 9 is a cross sectional view of a rotation assembly of the foldable cart according to one aspect of the present disclosure.

Similar numbers refer to similar parts throughout the drawings.

### DETAILED DESCRIPTION

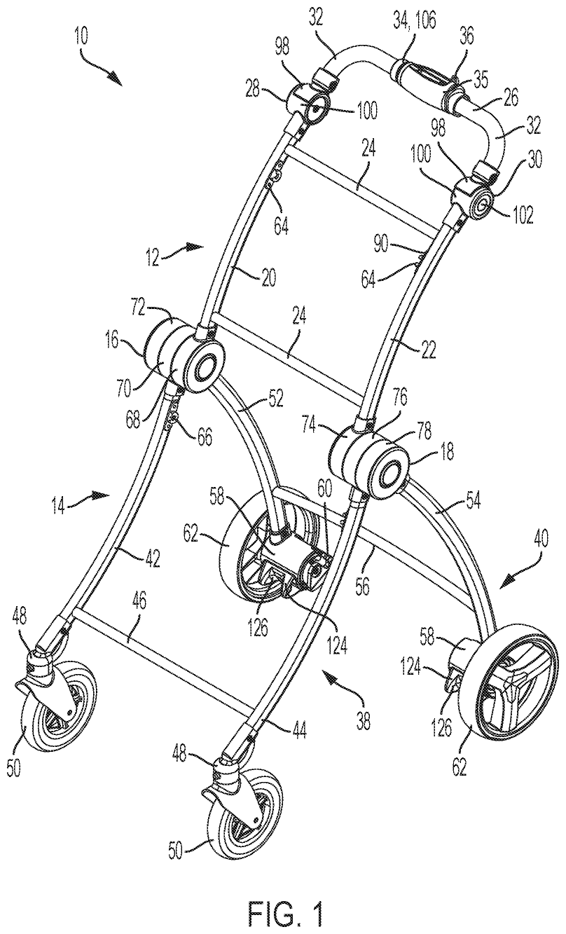

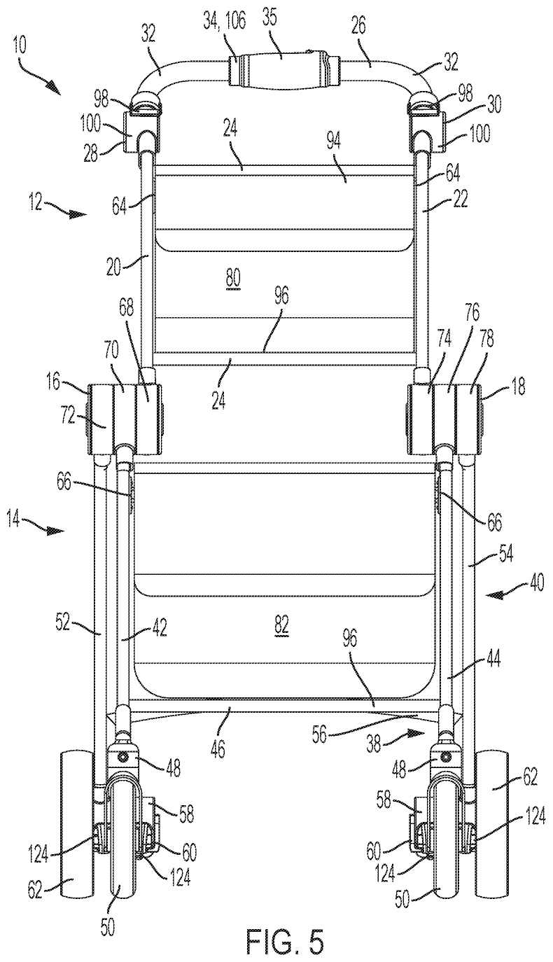

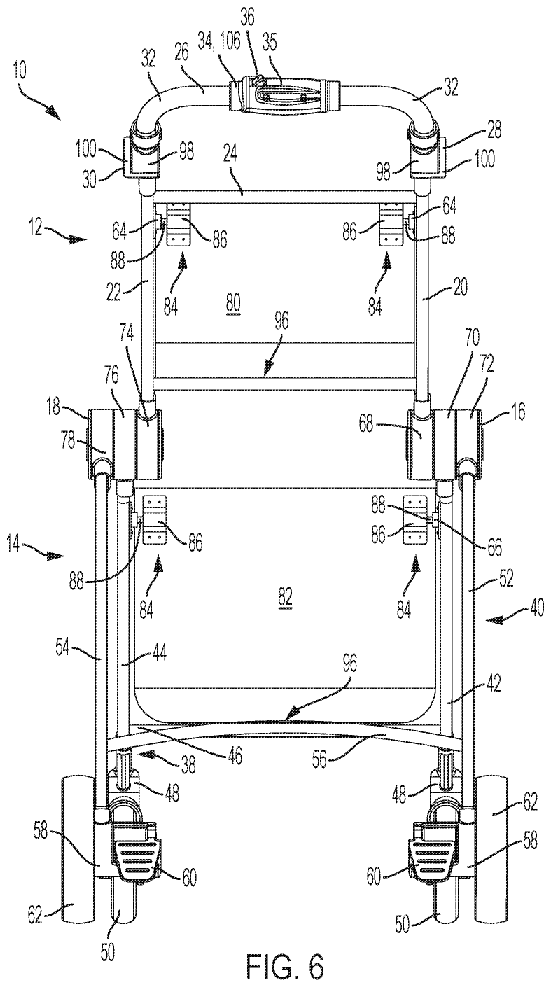

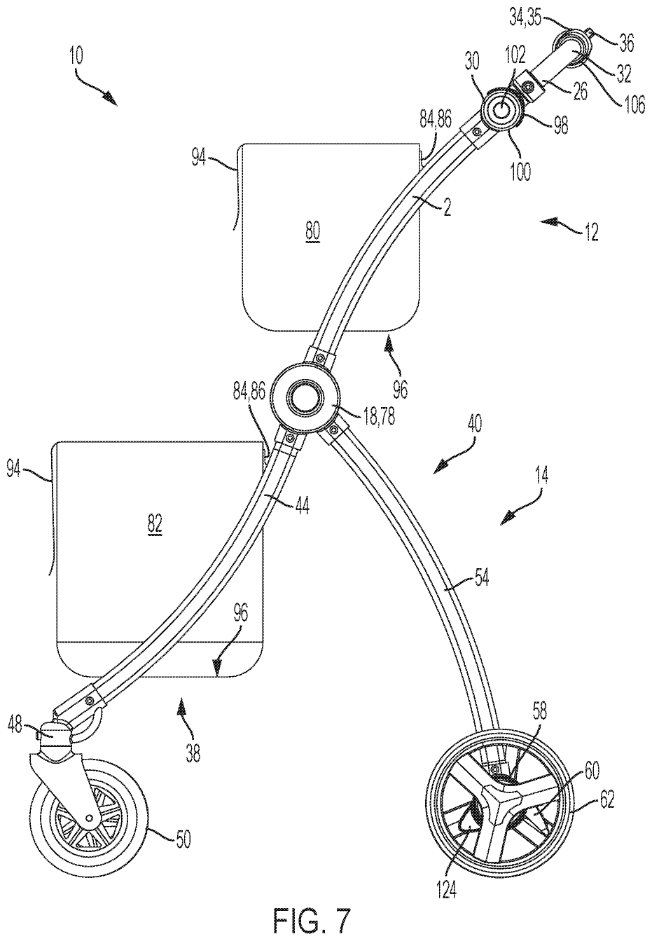

With reference to FIGS. 1-7, a folding utility cart is shown and generally indicated at reference 10. Foldable cart 10 hereinafter referred to as cart 10 may include an upper frame 12, a lower frame 14, a first rotation assembly 16, and a second rotation assembly 18. Generally speaking, when configured as shown in FIG. 1 as a four wheeled cart, first and second rotation assemblies 16, 18 may generally form a central hub from which upper frame 12 and lower frame 14 may extend. Generally speaking, lower frame 14 may extend downwards towards the ground from first and second rotation assemblies 16, 18 while upper frame 12 may be the portion of cart 10 extending generally upwards (and slightly rearwards) from first and second rotation assemblies 16, 18.

Upper frame 12 may have a first frame arm 20 and a second frame arm 22 which may be generally parallel and spaced apart from one another defining a transverse direction therebetween. The first and second arms 20 and 22 may define the upper sides of the upper frame 10. Upper frame 12 may also include one or more upper cross members 24 which may extend laterally between first and second frame arm 20, 22 to provide support thereto and to further assist in maintaining the parallel relationship between first and second frame arms 20, 22. Upper frame 12 may include a handlebar 26 which may be pivotably attached to first and second frame arms 20, 22 through a first pivot lock 28 and a second pivot lock 30. Handlebar 26 may have curved corners 32 which may allow handlebar 26 to connect to the generally upright first and second frame arms 20, 22, but also extend therebetween to form or otherwise connect with a handle 34.

Upper frame 12 may be formed from steel, aluminum, aluminum alloy, steel alloy, titanium, plastic, or any other suitable rigid materials and may be manufactured using any known and suitable manufacturing technique, including milling, extrusion, roll forming, molding, or the like. According to one aspect, first and second arms 20, 22 may be formed from extruded aluminum. First and second arms 20, 22 may have a square shaped or rectangular shaped cross-section and may be slightly curved or arcuate between the rotation assemblies 16, 18 and the pivot locks 28, 30. According to another aspect, arms 20, 22 may have any suitable cross-sectional shape including oval, elliptical, round, or the like.

According to one aspect, handlebar 26 may be extruded from aluminum and may have a hollow interior with a round or slightly oblong shaped cross-section. Handlebar 26 may be coated or textured to improve grip and comfort for the operator during use. According to one aspect, handlebar 26 may have a foam or rubber grip or coating applied thereto. According to another aspect, handlebar 26 may have a removable cover attached thereto. Where first utility bin 80 (discussed below) is installed, secondary handlebar may extend behind first utility bin 80 as dictated by the desired implementation.

According to one aspect, upper frame 12 may have a secondary handlebar (not shown) which may be extend between arms 20 and 22 and may assist the user or operator of cart 10 when cart 10 is operated in the dolly configuration, as discussed further below. This secondary handlebar may be positioned lower than handlebar 26 and may be configured to provide a more comfortable or more accessible grip for maneuvers such as lifting cart 10 up a flight of stairs, or for lowering cart 10 down a flight of stairs, for example. Accordingly, secondary handlebar may be substantially similar to handlebar 26, but for its placement on cart 10, and may include any or all features thereof, including, but not limited to, a grip or textured coating, a cover, or the like.

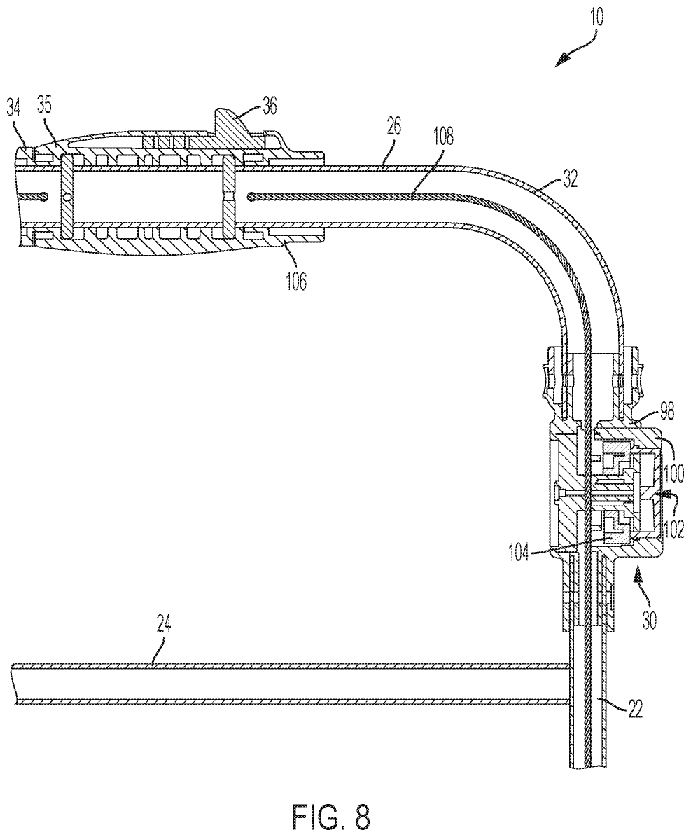

First and second pivot lock 28, 30 may allow handlebar 26 to be positioned at multiple angles relative to the first and second arms 20, 22 to allow an operator to adjust the height of handlebar 26 to suit their individual comfort level during use. Pivot locks 28, 30 may therefore be any standard pivoting or rotating lock as commonly used in instances where a handle or similar structure is desired to be rotationally adjusted relative to a frame. Pivot locks 28, 30 are discussed further below with reference to FIG. 8.

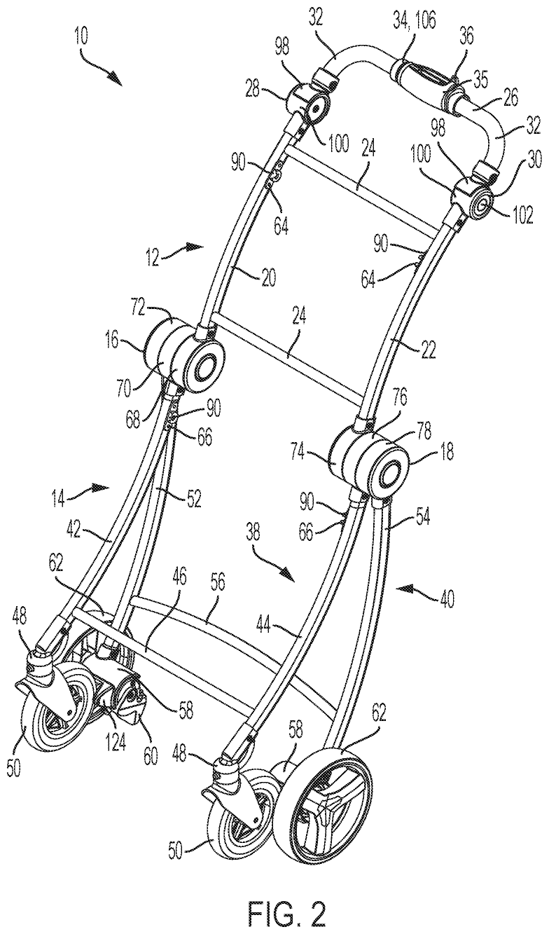

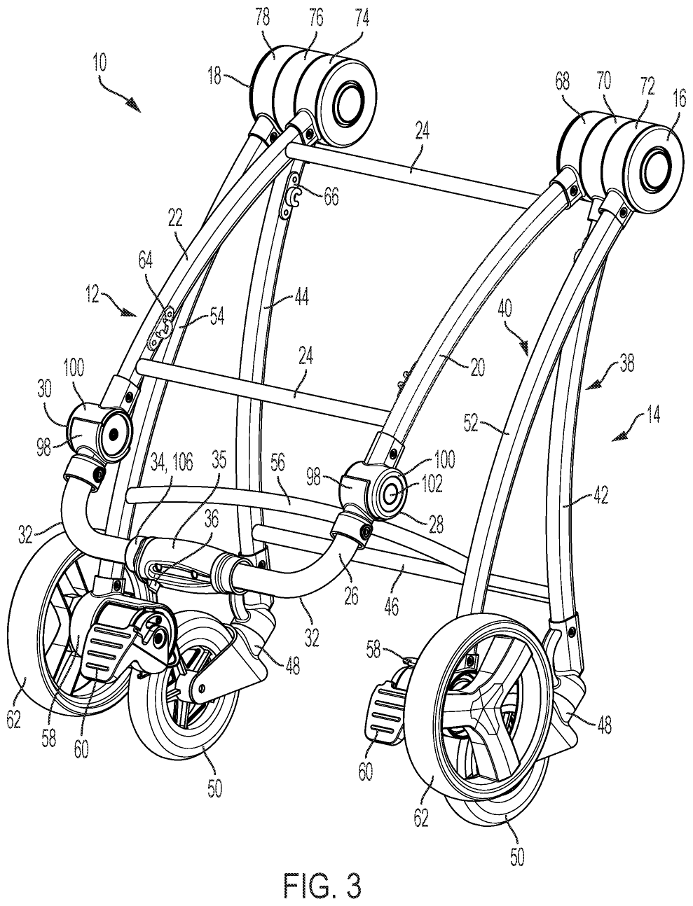

Handle 34 may be a rotating handle 34 or may alternatively have a rotating central portion 35. Rotating central portion 35 may facilitate switching the cart 10 between a the forward pushing configuration (as shown in FIG. 1), a dolly configuration (FIG. 2), and a storage configuration (FIG. 3) through its interactions with first and second rotation assemblies 16 and 18, as discussed further below. Handle 34 may further include a thumb lock 36 that may prevent rotation of the central portion 35 of handle 34 unless desired. According to one aspect, handle 34 may be formed around handlebar 26 such that handlebar 26 may extend through a body 106 of handle 34. According to another aspect, handle 34 may be a complete unit that may attach to handlebar 26 on either side such at handlebar 26 may be two pieces that extend between handle 34 and first and second arms 20, 22.

Upper frame 12, or more particularly, first and second arms 20, 22 may include upper bin mounts 64 connected thereto which may facilitate connection to a utility bin 80 or 82 as discussed further herein. Upper bin mounts 64 may include a c-shaped or similar channel 90 which may connect to a pin 88 on a utility bin 80 or 82, as discussed further herein. Upper bin mounts 64 may be fastened or otherwise connected to first and second arms 20, 22 through any suitable means including screws, bolts, rivets, clips, or the like.

Lower frame 14 may have a front portion 38 and a rear portion 40 which, when configured in the four wheeled “the forward push configuration,” may be spaced apart and define a longitudinal direction therebetween that is substantially parallel to the main direction of travel (both forwards and backwards). In essence, front portion 38 may be the lower frame 14 portion carrying the front wheels 50 while rear portion 40 may be the lower frame 14 portion carrying the rear wheels 62.

Front portion 38 may include a first front leg 42 and a second front leg 44 which may be spaced apart along the transverse direction and may generally correspond to first arm 20 and second arm 22, respectively. First and second front legs 42 and 44 may define the sides of the front portion 38 of lower frame 14. First and second front legs 42, 44 may be transversely spaced apart by a distance that is slightly greater than the distance by which first and second arms 20, 22 are spaced. This spacing may allow for the arms 20, 22 and front legs 42, 44 to be aligned adjacent to one another when cart 10 is in storage configuration (FIG. 3, discussed below). First and second front legs 42, 44 may each connect to a caster 48 at the bottom end thereof. Casters 48 may each carry a front wheel 50 to further provide a pair of front wheels 50 to cart 10.

As with first and second arms 20, 22, first and second legs 42, 44 may be formed from steel, aluminum, aluminum alloy, steel alloy, titanium, plastic, or any other suitable rigid materials and may be manufactured using any known and suitable manufacturing technique, including milling, extrusion, roll forming, molding, or the like. According to one aspect, first and second front legs 42, 44 may be formed from extruded aluminum. First and second front legs 42, 44 may have a square shaped or rectangular shaped cross-section and may be slightly curved or arcuate between the rotation assemblies 16, 18 and the casters 48 disposed at the bottom ends thereof. According to another aspect, first and second front legs 42, 44 may have any suitable cross-sectional shape including oval, elliptical, round, or the like.

Front portion 38 may include a first lower cross member 46 which may extend between first front leg 42 and second front leg 44 in the transverse direction to provide support to front portion 38 and to help maintain the positional relationship between first and second front legs 42, 44.

Front portion 38, or more particularly, first and second front legs 42, 44 may include lower bin mounts 66 connected thereto which may facilitate connection to a utility bin 80 or 82. Lower bin mounts 66 may be substantially similar or identical to upper bin mounts 64 and may include a c-shaped or similar channel 90 which may connect to a pin 88 on a utility bin 80 or 82, as discussed further herein. Lower bin mounts 66 may be fastened or otherwise connected to first and second front legs 42, 44 through any suitable means including screws, bolts, rivets, clips, or the like.

According to one aspect, casters 48 may be any suitable caster type as dictated by the desired implementation. According to another aspect, casters 48 may be locking casters which may operate to allow free, 360° movement of front wheels 50 when unlocked and may restrict movement of front wheels 50 to linear forward and linear backward movement when casters 48 are in a locked position.

Front wheels 50 may be all-season type wheels and may be formed of a suitable material for use on all types of terrains, including pavement, asphalt, tile, wood, linoleum, grass, dirt, or any other ground surface that may be encountered. According to one aspect, front wheels 50 may include a rubberized outer surface or alternatively may include a tire or the like disposed thereon to further assist in grip and maneuverability of cart 10.

Rear portion 40 may have a first rear leg 52 and a second rear leg 54 which may be spaced apart along the transverse direction and may generally correspond to first arm 20 and second arm 22, respectively. First and second rear legs 52 and 54 may define the sides of the rear portion 40 of lower frame 14. First and second rear legs 52, 54 may be transversely spaced apart by a distance that is slightly greater than the distance by which first and second front legs 42 and 44 are spaced. This spacing may allow for the front legs 42, 44 and rear legs 52, 54 to be aligned adjacent to one another when cart 10 is in storage configuration (FIG. 3, discussed below). First and second rear legs 52, 54 may each connect to braking hubs 58 at the bottom end thereof.

Braking hubs 58 may include a brake mechanism 60 thereon and may further support a pair of rear wheels 62. Brake mechanism 60 may be a standard brake or locking mechanism that may allow for the rear wheels 62 to be locked to prevent unwanted or undesired movement thereof, such as when cart 10 is parked on a sloped surface. Braking hubs 58 of rear wheels 60 may each further include a pair of projections or fingers 124 that may be spaced apart and define a channel 126 therebetween which may accept front wheels 50 therein when cart 10 is configured in the dolly configuration as best pictured in FIG. 2. Fingers 124 may prevent rotation of casters 48 and/or front wheels 50 to facilitate ease of use and prevent unwanted wheel movement while operating cart 10 in dolly configuration as seen in FIG. 2. Further, front wheels 50 may be supported by fingers 124 and channel 126 in the dolly configuration as the front wheels may be lifted off of the ground surface.

As with first and second arms 20, 22 and first and second legs 42, 44, first and second rear legs 52, 54 may be formed from steel, aluminum, aluminum alloy, steel alloy, titanium, plastic, or any other suitable rigid materials and may be manufactured using any known and suitable manufacturing technique, including milling, extrusion, roll forming, molding, or the like. According to one aspect, first and second rear legs 52, 54 may be formed from extruded aluminum. First and second rear legs 52, 54 may have a square shaped or rectangular shaped cross-section and may be slightly curved or arcuate between the rotation assemblies 16, 18 and the braking hubs 58. According to another aspect, first and second front legs 42, 44 may have any suitable cross-sectional shape including oval, elliptical, round, or the like.

Rear portion 40 may include a second lower cross member 56 which may extend between first rear leg 52 and second rear leg 54 in the transverse direction to provide support to rear portion 40 and to help maintain the positional relationship between first and second rear legs 52, 54. Second lower cross member 56 may be placed slightly above first lower cross member 46 relative to the ground surface to prevent the cross members 46 and 56 from interfering with one another when cart 10 is placed in the storage configuration. According to another aspect, second lower cross member 56 may be arcuate and may arch up and/or away from first lower cross member 46 for the same purpose. Second lower cross member 56 may further facilitate easier transitions between the possible configurations of cart 10, as discussed further below.

As with front wheels 50, rear wheels 62 may be all-season type wheels and may be formed of a suitable material for use on all types of terrains, including pavement, asphalt, tile, wood, linoleum, grass, dirt, or any other ground surface that may be encountered. According to one aspect, rear wheels 62 may include a rubberized outer surface or alternatively may include a tire or the like disposed thereon to further assist in grip and maneuverability of cart 10.

First and second rotation assemblies 16 and 18 may be generally cylindrically shaped and may form central “hubs” from which the upper frame 12 and the front and rear portions 38, 40 of lower frame 14 may extend. Specifically, first rotation assembly may have an inner section 68 which may connect to first frame arm 20 of upper frame 12, a center section 70 which may connect to first front leg 42, and an outer section 72 which may connect to first rear leg 52. Similarly, second rotation assembly 18 may have an inner section 74 connected to second frame arm 22, a center section 76 connected to second front leg 44, and an outer section 78 connected to second rear leg 54.

Each of inner section 68, center section 70, and outer section 72 of first rotation assembly 16 may be rotatable relative to each of the other of inner section 68, center section 70, and/or outer section 72. Similarly, each of inner section 74, center section 76, and outer section 78 of second rotation assembly 18 may be rotatable relative to each of the other of inner section 74, center section 76, and/or outer section 78. These rotatable relationships between the sections may facilitate conversion of cart 10 between the forward push configuration, the dolly configuration, and a storage configuration as discussed further herein.

It will be understood that first and second rotation assemblies 16, 18 may be substantially identical to each other except that each may be a mirror image of the other depending on which side they are positioned on cart 10. The internal construction and operations of rotation assemblies 16 and 18 are discussed further below.

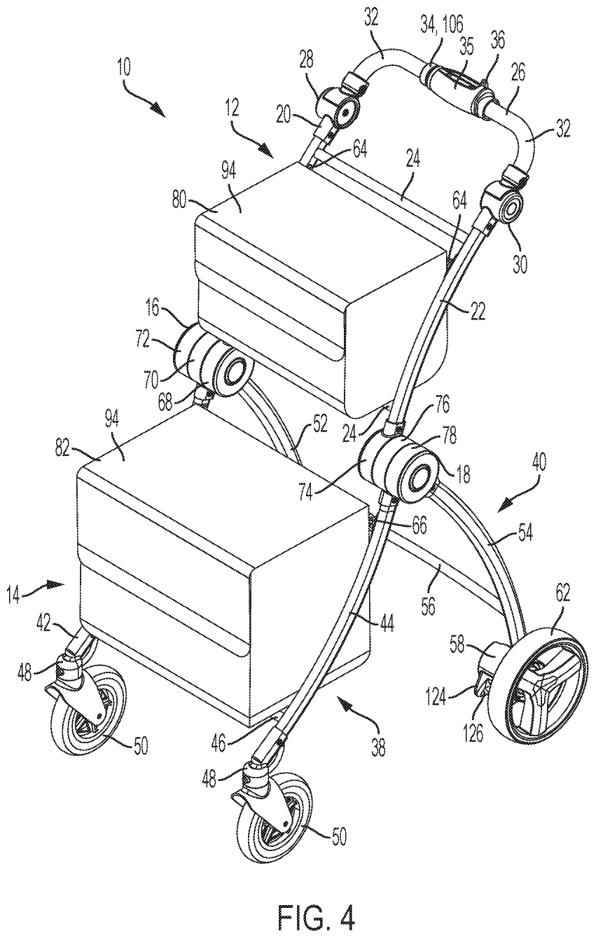

With reference to FIGS. 4-7, cart 10 may further include a first utility bin 80 and a second utility bin 82 which may be substantially rectangular or square-shaped bins having an open interior (not shown) and a cover 94. Utility bins 80, 82 may be sized to fit between first and second frame arms 20, 22 and/or first and second front legs 42, 44 such that cart 10 may carry and support utility bins 80, 82 thereon as discussed below. Cover 94 of utility bins 80, 82 may further include a handle (not shown) that may facilitate the attachment and detachment of utility bins 80, 82 from bin mounts 64, 66, as discussed below. Utility bins 80, 82 may further have a bottom 96 that may support any materials or goods carried therein and may also rest on cross members 24 and/or 46 to further support the weight of utility bins 80, 82 and the contents thereof when cart 10 is being used as discussed below. Utility bins 80, 82 may be soft sided and collapsible and may be folded for storage when not equipped on cart 10, or may alternatively be folded while cart 10 is in the storage configuration. According to another aspect, bins 80, 82 may be rigid or non-collapsible and may be removed for storage or when cart 10 is in the storage configuration.

Utility bins 80, 82 may removably connect to upper bin mounts 64 and lower bin mounts 66. According to one aspect, first utility bin 80 may be connected to upper bin mounts 64 while second utility bin 82 may be connected to lower bin mounts 66. According to another aspect, these positions may be reversed. First and second utility bins 80, 82 may include pin connectors 84 which may have a bin portion 86 and a pin 88 extending therefrom for connection to upper and lower bin mounts 64, 66. Specifically, pin 88 may extend laterally from bin portion 86 of pin connectors 84 and may be slideably received within C-shaped channels 90 formed within upper and lower bin mounts 64, 66. According to another aspect, bins 80, 82 may connect directly to the arms 20, 22 and/or legs 42, 44, 52, and 54, of cart 10 through any suitable means, including hooks, clips, adhesives, hook and loop material, ties, or the like.

According to one aspect that is not shown in the figures, cart 10 may further include a rear basket that may be affixed to the rear portion 40 of lower frame 14 and may accommodate additional items or goods therein. According to this aspect, rear basket may be a mesh cargo net similar to those found on child strollers or other similar devices. According to another aspect, rear basket may be a third utility bin or the like.

According to one aspect, cart 10 may further include other accessories, such as cup holders, bag or purse hooks, a console, a tray, a locking storage compartment, a retractable locking cable, a phone mount or mounting bracket, or the like. According to another aspect, cart 10 may include electronic components and the wiring therefor. For example, cart 10 may include speakers and audio cables for connection to an external device. According to another aspect, cart 10 may include a battery pack or battery with a USB port for connection to external devices, such as a smart phone or the like. According to another aspect, cart 10 may include additional safety features, such as reflective strips, lights, or the like.

With reference now to FIG. 8, a cross-section of a portion of handlebar 26, second pivot lock 30, and handle 34 are shown and will now be discussed. With regards to second pivot lock 30, it will be understood that first pivot lock 28 may be similar in structure and operation and may be substantially similar to second pivot lock 30 but for being a mirror image thereof as it is disposed on the opposite of cart 10. Specifically, and according to one aspect, second pivot lock 30 may have a body 98 exterior of a central hub 100 which may allow for rotational movement of body 98 around central hub 100. Second pivot lock 30 may further include a latching mechanism, such as a push button 102, which may disengage an internal locking mechanism 104 to allow rotational movement of body 98 about central hub 100. The inclusion of first and second pivot locks 28, 30 may facilitate adjustment of handlebar 26 to various positions to account for the height of the person operating cart 10. The locking mechanism 104 may therefore include any number of pivot stops or stopping members to provide predetermined stopping points to lock handlebar 26 in a desired position. According to another aspect, first and second pivot locks 28, 30 may utilize a tension member or tension lock (not shown) to hold handlebar 26 in the desired position.

As discussed above, handle 34 may have a central portion 35 disposed generally in the center of handle 34 with a thumb lock 36 operationally connected thereto. Thumb lock 36 may be operable to lock central portion 35 relative to body 106 of handle 34 to prevent rotational movement of central portion 35 until desired. Central portion 35 of handle 34 may attach to a cable 108 that may extend through the hollow interior of first and second frame arms 20, 22 down to first and second rotation assemblies 16, 18, respectively.

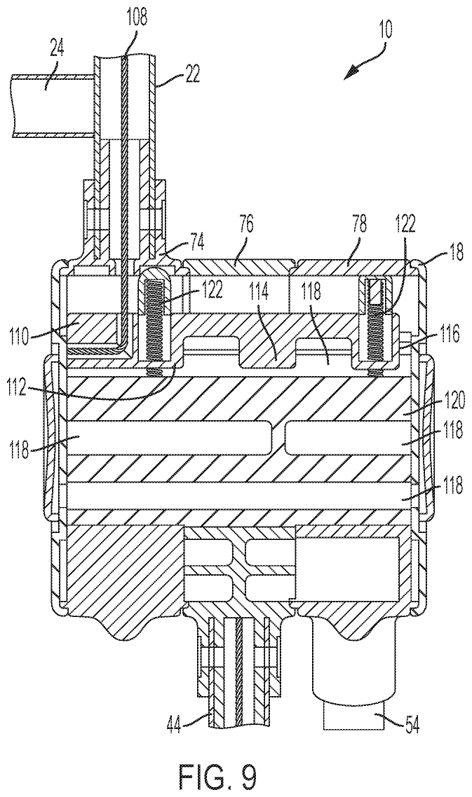

With reference now to FIG. 9, a cross-section of a rotation assembly (specifically second rotation assembly 18) is shown. It will be generally understood that both first and second rotation assemblies 16, 18 may be substantially similar but for their placement on cart 10, therefore the cross-section view shown in FIG. 9 may be described relative to second rotation assembly 18 but will be equally applicable to both first and second rotation assemblies 16 and 18. As seen in FIG. 9, cable 108 may extend down from the frame arm 20 and attach to locking bar 110 within second rotation assembly 18. Locking bar 110 may have a first locking flange 112, a second locking flange 114, and a third locking flange 116 which may engage one of three sets of depressions 118 within rotating central cylinder 120. Specifically, a first set of depressions 118 may provide a first position of the inner section 74, center section 76, and outer section 78 corresponding to the forward push configuration, while a second set of depressions 118 may correspond to the dolly configuration and a third set of depressions 118 may correspond to the storage configuration. The specific arrangement of depressions 118 may vary according to the desired implementation. As shown in FIG. 9, the locking bar 104 is engaged with first, second, and third locking flanges 112, 114, and 116 engaged with the first set of depressions 118 as cart 10 is in the forward push configuration. Locking bar 110 may further include one or more biasing springs 122 to maintain locking bar 110 in a locked position until moved by an operator of cart 10, as discussed further herein.

While each of inner section 74, center section 76, and outer section 78 may rotate relative to one another, central cylinder 120 may rotate along with the rotation of one or more of the three sections 74, 76 and/or 78 to align the depressions 118 with the first, second, and third locking flanges 112, 114, 116 of locking bar 110 to keep the inner, center, and outer sections 74, 76, 78 in a desired position relative to another and therefore to secure the upper frame 12 and the front and rear portions 38, 40 of lower frame 14 in their desired positions as well.

According to another aspect, locking bar 110 and depressions 118 may be configured to allow additional positions of upper and lower frames 12 and 14 relative to one another to be achieved. For example, locking bar 110 and depressions 118 may be configured to allow upper frame 12 to extend substantially horizontal to the ground surface. According to another aspect, locking bar 110 and depressions 118 may be configured to prevent movement of one element relative to another. For example, locking bar 110 and depressions 118 may be configured such that upper frame 12 and handle 26 may be locked and immovable relative to lower frame 14.

As described herein, rotation assemblies 16 and 18 have three rotating sections and an internal locking mechanism utilizing locking bar 110 and rotating cylinder 120 to transition between the various configurations of cart 10; however; it will be understood that other suitable rotating locks may be integrated with cart 10 that may still provide three distinct configurations of upper and lower frame 12 and 14 relative to one another. It is therefore contemplated that other suitable locking mechanisms may be utilized for cart 10 while remaining within the scope of this disclosure.

Although disclosed and discussed herein as a general use utility cart 10, it will be understood that the features and elements thereof may be readily adapted for use with similar devices. By way of one non-limiting example, the elements and components of cart 10 may be adapted for use with an infant or toddler stroller to provide a stroller that may convert between a four-wheeled configuration and a two-wheeled configuration while securely carrying a child or children. According to another non-limiting example, the elements and components of cart 10 may be adapted for use as a specialized use cart, such as a sports cart (e.g. a golf caddy cart), a delivery cart, or moving cart. It will be further understood that other applications of the elements and components of cart 10 as discussed herein may be readily and easily adapted for use therein, and are therefore expressly considered to be within the scope of the present disclosure.

Having discussed the cart 10 and the various elements and components thereof, the operation and method of use will now be discussed.

Foldable cart 10 is contemplated for use as a general use utility cart that may be configured in multiple modes. With reference to FIGS. 1 and 4-7, cart 10 may first be configured in a forward push configuration wherein all four wheels (i.e. front wheels 50 and rear wheels 62) are deployed and in contact with a ground surface. In this configuration, an operator may simply utilize cart 10 to carry goods and materials in one or both of first and second utility bins 80 and/or 82 as desired. The casters 48 on front wheels 50 may allow for smooth turning and high mobility to cart 10 when configured in the forward push configuration.

Utility bins 80 and/or 82 may be easily connected to and/or removed from cart 10 by inserting or removing pins 88 of pin connectors 84 from the C-channels 90 of upper and lower bin mounts 64, 66. The cover 94 of bins 80, 82 may be easily opened to allow insertion and removal of items from within the bins 80, 82 or may alternatively be closed to protect the contents thereof from elements and/or to keep them out of view as desired. Cover 94 may be secured in a closed or open position through any suitable means, including snaps, hook and loop closures, buckles, or the like. According to one aspect, cover 94 may be weighed or formed of heavier materials to assist in keeping cover 94 closed or open as desired.

With reference to FIG. 2, cart 10 may alternatively be operated in a dolly configuration wherein only the rear wheels 62 are in contact with the ground surface. When used in dolly configuration, cart 10 may be positioned more upright and may be tilted and best operated by being pulled by the operator. The dolly configuration may be utilized as desired, but may be most useful in maneuvering through tight spaces, such as narrow doorways, narrow walkways, crowded areas, or the like, or in traversing up and down stairs or steep inclines as the cart 10 may be tilted to a greater angle to assist an operator in transporting the load across difficult terrain.

Conversion of cart 10 between the forward push configuration and dolly configuration may be accomplished through the following method. First, if converting cart 10 from the forward push configuration to dolly configuration, a user may displace thumb lock 36 towards the center of handle 34 while simultaneously rotating the central portion 35 backwards towards the user's person. This may cause cable 108 to wind around or otherwise be pulled by handle 34, thus providing tension on cable 108 which in turn may raise the locking bar 110 contained within the first and second rotation assemblies 16, 18. With locking bar 110 raised against the bias of springs 122, the inner center and outer sections 68, 70, 72 of first rotation assembly 16 and the inner, center, and outer sections 74, 76, 78 of second rotation assembly 18 are now free to rotate relative to one another about the center cylinder 120. To then transition from the forward push configuration to the dolly configuration, a user simply pulls back on the handle 34 while simultaneously pushing the rear portion 40 of lower frame 14 towards the front portion 38 of lower frame 14 with their foot. A slight upward pressure may be applied to second lower cross member 56 to further facilitate movement of first and second rear legs 52, 54 of rear portion 40 towards first and second front legs 42, 44 of front portion 38. As front portion 38 and rear portion 40 of lower frame 14 come together, the front wheels 50 may engage within the channel 126 between fingers 124 on the braking hubs 58 to secure the front wheels 50 up and off of the ground surface, as well as to prevent them from rotating about their casters 48.

Where cart 10 is provided with locking casters 48, casters 48 may be locked prior to beginning the transition between forward push configuration and dolly configuration.

Once the rear portion 40 of lower frame 14 has been rotated into place in dolly configuration, the operator may rotate central portion 35 of handle 34 back to its original position and release thumb lock 36 to lock the front and rear portions 38, 40 in position relative to one another. Alternatively, the user may simply let go of central portion 35 and biasing springs 122 will pull locking bar 110 back into position, which will, in turn, pull cable 108 to rotate central portion back into its original position.

If converting from forward push configuration to storage configuration, an operator may perform the same steps above to first convert cart 10 into dolly configuration, but prior to returning central portion 35 of handle 34 back to its original position, the operator may further rotate the upper frame 12 downward towards the rear portion 40 of lower frame 14. Once upper frame 12 has been fully rotated to be in position adjacent to lower frame 14 or more particularly the rear portion 40 thereof, cart 10 is now in compact storage configuration and the operator may again release central portion 35 of handle 34 and thumb lock 36 to allow cart 10 to be locked in this position.

To transition from dolly configuration to forward push configuration, the operation above may be reversed in that a user may first displace thumb lock 36 before rotating the central portion 35 of handle 34 and separating the rear portion 40 from the front portion 38 of lower frame 14 to remove the front wheels 50 from the channel 126 and return rear wheels 62 back to their rearward position. Again, a user may utilize second lower cross member 56 and foot to assist in moving front and rear portions 38 and 40 of lower frame 14 relative to one another.

Similarly, to convert the cart 10 from storage configuration to one of dolly configuration or forward push configuration, the user may again reverse the previous steps in that they may first depress thumb lock 36 before rotating the central portion 35 of handle 34 and raising the upper frame 12 away from the rear portion 40 of lower frame 14. If the user desires to convert to dolly configuration, once the upper frame 12 is raised, no further steps are required and the user may release the handle 34 allowing central portion 35 thereof to return to its original position. If the user desires to further convert from dolly configuration to forward push configuration, they need perform the steps discussed above.

It is contemplated that first and second utility bins 80 and/or 82 may remain connected to cart 10 in all three modes and may therefore be collapsible or otherwise stowable to accommodate any desired mode or configuration of cart 10; however, where bins 80, 82 have been removed, they may be replaced at any point during the transitions, as desired by the user's preference and particular need at that particular time.

According to the aspect where cart 10 includes a rear basket affixed to the rear portion 40 of lower frame 14, it is contemplated that such a rear basket may also be stowable or collapsible to accommodate the varying modes of cart 10.

For further storage and/or breakdown and according to one aspect, cart 10 may be equipped with removable front and/or rear wheels 50 and/or 62 to allow further reduction in size for storing and/or transport of cart 10.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A foldable cart comprising:
an upper frame extending generally upwards from a first rotation assembly and a second rotation assembly when the cart is in a first configuration;
a front portion of a lower frame extending generally downwards and forwards from the first and second rotation assemblies when the cart is in the first configuration;
a rear portion of a lower frame extending generally downwards and rearwards from the first and second rotation assemblies when the cart is in the first configuration;
a first pair of wheels carried by the front portion of the lower frame for operational engagement with a ground surface; and
a second pair of wheels carried by the rear portion of the lower frame for operational engagement with a ground surface.

2. The foldable cart of claim 1 wherein the cart is reconfigurable from the first configuration wherein the front portion of the lower frame is spaced apart from the rear portion of the lower frame in a longitudinal direction to a second configuration wherein the front portion of the lower frame is adjacent the rear portion of the lower frame.

3. The foldable cart of claim 2 wherein the cart is reconfigurable from the second configuration to a third configuration wherein the upper frame is adjacent the front and rear portions of the lower frame.

4. The foldable cart of claim 2 wherein the first pair of wheels do not touch a ground surface when the cart is in the second configuration.

5. The foldable cart of claim 2 further comprising:
a first utility bin in operable communication with the upper frame; and
a second utility bin in operable communication with the front portion of the lower frame.

6. The foldable cart of claim 5 wherein the first and second utility bins are removable.

7. The foldable cart of claim 5 wherein the first and second utility bins are collapsible.

8. The foldable cart of claim 2 wherein the cart is a stroller.

9. The foldable cart of claim 2 wherein the cart is a utility cart when configured in the first position; a dolly when configured in the second position; and in a storage condition when configured in the third position.

10. A method of reconfiguring a utility cart comprising:
unlocking a first rotation assembly and a second rotation assembly of a utility cart;
moving a rear portion of a lower frame of the utility cart from a first position wherein a rear portion of a lower frame extends generally downwards and rearwards from the first and second rotation assemblies to a second position wherein the rear portion of the lower frame is adjacent to a front portion of the lower frame extending generally downwards and forwards from the first and second rotation assemblies; and
locking the first and second rotation assemblies in position.

11. The method of claim 10 wherein a first pair of wheels on the front portion of the lower frame do not touch the ground surface when the cart is in the second configuration.

12. The method of claim 11 wherein a second pair of wheels on the rear portion of the lower frame engage the ground surface in the first and second positions.

13. The method of claim 10 further comprising:
moving an upper frame of the utility cart from a first position wherein the upper frame extends generally upwards from the first and second rotation assemblies to a third position wherein the upper frame is adjacent to the front and rear portions of the lower frame prior when the front and rear portions are in the second position.

14. The method of claim 13 wherein the cart further comprises:
a first removable utility bin in operable communication with the upper frame; and
a second removable utility bin in operable communication with the front portion of the lower frame.

15. The method of claim 14 further comprising:
removing the first utility bin from the upper frame before rotating the upper frame into the third position.

16. The method of claim 14 further comprising:
removing the second utility bin from the front portion of the lower frame before rotating the rear portion of the lower frame into the second position.

17. The method of claim 10 wherein unlocking the first and second rotation assemblies are accomplished by rotating a lockable rotating handle.

18. A method of transporting materials comprising:
placing an item to be transported into a utility bin carried by a cart having an upper frame, a lower frame, a first pair of wheels operably connected to a front portion of the lower frame, and a second pair of wheels operably connected to a rear portion of the lower frame;
causing the cart to be moved relative to a ground surface while in a first position wherein the first pair of wheels and the second pair of wheels are engaged with the ground surface;
rotating the rear portion of the lower frame towards the front portion of the lower frame to a second position wherein the first pair of wheels do not engage the ground surface; and
causing the cart to move relative to the ground surface in the second position.

19. The method of claim 18 further comprising:
removing the item to be transported from the utility bin; and
rotating the upper frame to a third position wherein the upper frame is adjacent the first and second portions of the lower frame.

20. The method of claim 19 further comprising:
storing the cart in the third position.
